(19) United States
(12) Patent Application Publication
(10) Pub. No.: US 2025/0222345 A1
(43) Pub. Date: Jul. 10, 2025

(54) Systems, Devices And Methods For Transmitting Data To A Virtual Reality Headset

(71) Applicant: Sony Interactive Entertainment Inc., Tokyo (JP)

(72) Inventors: Lawrence Martin Green, London (GB); Patrick John Connor, London (GB); Maria Chiara Monti, London (GB); Jun Yen Leung, London (GB); Maurizio Cerrato, London (GB); Rajeev Gupta, London (GB)

(73) Assignee: Sony Interactive Entertainment Inc., Tokyo (JP)

(21) Appl. No.: 19/013,315

(22) Filed: Jan. 8, 2025

(30) Foreign Application Priority Data
Jan. 10, 2024 (GB) GB2400322.0

(51) Int. Cl. A63F 13/235; A63F 13/212; A63F 13/213

(52) U.S. Cl. CPC A63F 13/235; A63F 13/212; A63F 13/213; A63F 2300/8082

(57) ABSTRACT

Described herein is a system for transmitting data to a virtual reality headset. The system comprises a video game console; a laser array comprising one or more lasers, wherein the video game console is configured to transmit console data to the laser array; and a virtual reality headset comprising one or more headset sensors, wherein the laser array is configured to transmit the console data to the one or more headset sensors via the one or more lasers of the laser array.

### CROSS-REFERENCE TO RELATED APPLICATION

The present application claims priority from United Kingdom Patent Application No. GB2400322.0 filed Jan. 10, 2024, the disclosure of which is hereby incorporated herein by reference.

### FIELD OF THE INVENTION

The present invention relates to systems, devices and methods for transmitting data to a virtual reality headset. In particular, the present invention relates to improvements in systems, devices and methods for transmitting video game data to a virtual reality headset.

### BACKGROUND

An issue associated with modern virtual reality (VR) headsets is that achieving a high-quality video output from the screen of the headset, whilst maintaining portability of the headset, can be difficult. For example, transmitting uncompressed video data to a VR headset requires a high bit rate data transfer. As VR headsets must be wearable by a user, it is often not practical to secure a large and heavy high-performance device that can facilitate such a high bit rate data transfer onto a user's body.

VR headsets known in the art circumvent this issue by establishing a physical connection between the VR headset and a graphical processing unit (GPU) of a host device such as a computer or video game console. This is undesirable as a physical tether is introduced between the wearer of the VR headset and the host device. This can restrict the movement of the wearer and can create a trip hazard. In many video game scenarios supported by a VR headset the wearer of the headset is required to move around. Typical movements include moving the arms and walking forwards, backwards and side to side. It is therefore undesirable to introduce a physical tether between the wearer and the host device.

A further difficulty present with achieving a high-quality video output from the screen of the headset is that standard wireless means for transmitting data, such as radio signals, Bluetooth and Wi-Fi, do not provide the necessary bandwidth required to transmit the uncompressed video data to a VR headset. These mechanisms can suffer from saturation when transmitting the required quantity of data at an acceptable latency. Furthermore, crosstalk from other nearby devices operating on the same network can disrupt these uncompressed video data transmissions.

There is therefore a need to improve the quality of the video output from the screen of a VR headset, whilst maintaining portability of the headset and ensuring the safety of the wearer of the headset.

### SUMMARY OF INVENTION

In an aspect of the present invention there is provided a system for transmitting data to a virtual reality headset, comprising: a laser array comprising one or more lasers, wherein the laser array is configured to receive console data transmitted from a video game console; and a virtual reality headset comprising one or more headset sensors, wherein the laser array is configured to transmit the console data to the one or more headset sensors via the one or more lasers of the laser array.

In this way, the transfer of data to a VR headset can be improved as a laser signal can provide the required bandwidth. High detail frame buffers rendered by the console can be sent to the headset to be displayed without requiring a wired connection to the headset. Therefore, the quality of the video output from the screen of a VR headset is improved, whilst also maintaining portability of the headset and ensuring the safety of the wearer of the headset. In this way, there is also no need to secure a large and heavy high-performance device onto a user's body that can facilitate a high bandwidth.

The laser array is preferably configured to transmit the console data to the one or more headset sensors by encoding the console data in a laser beam emitted from the laser array to the one or more headset sensors. In this way the data is transmitted wirelessly. Alternatively defined, the one or more lasers are configured to emit a direct laser beam towards the one or more headset sensors. In this context, a direct laser beam is light emitted from a laser that travels through free space, without being coupled into a fibre optic or a waveguide. It may also be referred to as a contactless or wireless laser beam. In this way, a high rate of data transfer to the VR headset can be achieved without the use of wires.

Preferably, the laser array is configured to be positioned above the virtual reality headset in use. The laser array may be oriented in a downward direction or may be configured to direct a laser downward toward the headset. The laser array may be mounted on the ceiling of a room when in use, for example.

In this way, when in use, this light path between the laser array and the headset will be infrequently blocked by the user. An unobstructed line of sight between the laser array and the headset is provided. Blocking the path between the laser array and the VR headset sensors would halt the transfer of data to the headset. Furthermore, in this way, laser signals transmitted to and by the laser array only have to travel a short distance and therefore will unlikely be scattered.

In various embodiments, the system further comprises one or more auxiliary laser arrays each comprising one or more auxiliary lasers, wherein the one or more auxiliary laser arrays are configured to receive the console data transmitted from the video game console, and wherein the one or more auxiliary laser arrays are configured to transmit the console data to the one or more headset sensors via the one or more auxiliary lasers of the one or more auxiliary laser arrays.

The auxiliary lasers may be placed at different locations to that of the laser array and orientated towards an expected position of the VR headset. There may be some scenarios where the path between the laser array and the VR headset is momentarily blocked, causing a halt in the data transfer via this path. Transmitting laser light directly across free space has the consequence that there is no way to bend or manoeuvre the laser light around a corner. In this way, the range of positions that the headset sensor can be reached is increased, as the console data can be transmitted over multiple different paths.

In various embodiments, the laser array comprises one or more array sensors configured to detect optical signals transmitted by the video game console and/or the virtual reality headset. In this way, the laser array can receive data from the console, the headset, or from other devices.

Preferably, the system further comprises a video game console, wherein the video game console comprises a console laser, and wherein the video game console is configured to transmit the console data to the one or more array sensors via the console laser. In this way, the need to connect the console and the laser using a wire is removed. The laser array is preferably positioned above a user when in use, for example on the ceiling. It is therefore advantageous to wirelessly transmit console data from the console to the laser array. By doing this via a laser signal, the bandwidth is also improved.

In various embodiments, the laser array is configured to track the motion of the virtual reality headset to determine a position of the virtual reality headset, and wherein the one or more lasers of laser array are configured to be orientated in a direction facing the virtual reality headset based on the determined position of the virtual reality headset.

In modern video game systems that support the use of VR headsets, a user is often required to move around in various gaming scenarios. Laser light is collimated and has a narrow beam width. If the laser array is fixed in place, then the data transfer to the user may halt if the users moves away from the path of the laser signal. Furthermore, transmitting laser light directly across free space has the consequence that there is no way to bend or manoeuvre the laser light around a corner. In this way, the laser signal can be directed at the VR headset when the user moves around. More specifically, the laser signal can be directed directly at laser sensors of the VR headset.

Preferably, the laser array comprises a motor configured to change the orientation the one or more lasers of the laser array based on the determined position of the virtual reality headset. The laser array may comprise a motorised gyroscope, for example. The motor may change the pitch and yaw of the one or more lasers to direct the laser signal onto the VR headset. The motor may also rotate the one or more lasers.

Preferably, the laser array tracks the motion of the virtual reality headset at least in part by tracking motion capture markers located on the virtual reality headset via a camera. In this way, the determination of the position of the headset can be improved. The motion capture markers of the headset may be located on an upper area of the headset. These can then be easily viewed by a camera of the laser array when it is installed above the headset in use.

Preferably, the virtual reality headset comprises a motion sensor configured to detect motion of the virtual reality headset, and wherein the motion sensor is configured to generate headset motion data based on the detected motion of the virtual reality headset. Preferably, the virtual reality headset is configured to transmit the headset motion data to the one or more array sensors, and wherein the laser array tracks the motion of the virtual reality headset based at least in part on the headset motion data. In this way, the determination of the position of the headset can be further improved.

Preferably, the virtual reality headset transmits the headset motion data to the one or more array sensors using a radio signal. The radio signal may be supported by Bluetooth® or Wi-Fi®, for example.

In various embodiments, the one or more headset sensors comprise one or more top-mounted sensors and/or one or more bottom-mounted sensors, wherein the top-mounted sensors are mounted on an upper section of the virtual reality headset and the bottom-mounted sensors are mounted on a lower section of the virtual reality headset. The one or more headset sensors are configured to receive a laser signal from above the headset and to receive a laser signal from below the headset. The one or more headset sensors may be orientated upwards downwards. In this way, the headset sensors can detect a laser signal from the laser array and/or auxiliary laser arrays regardless of where these arrays are positioned with respect to the headset.

In various embodiments, the console data comprises video data. Preferably, the video data is uncompressed. In this way, the video data can permit a high-quality video output from the VR headset.

In various embodiments, the one or more lasers transmit the console data by modulation of the laser light. Any of lasers in the system may transmit the console data in this manner. The lasers may transmit binary data by flashing on and off, or by flicking between two brightness settings.

In another aspect of the present invention there is provided a video game console, comprising: a console laser, wherein the console laser is configured to transmit video data generated by the video game console in a first direction; and one or more auxiliary laser arrays each comprising one or more auxiliary lasers, wherein the one or more auxiliary laser arrays are configured to transmit the video data in a direction different to that of the first direction.

The video game console may further comprise a memory configured to store video game data and a processor for rendering console data, preferably video data, based on the video game data stored in the memory. The console laser and the one or more auxiliary laser arrays may be integral with the body of the video game console. Alternatively, the auxiliary laser arrays may be a separate component of the video game console and may be connected to the video game console wirelessly or by a wired connection.

In another aspect of the present invention there is provided a laser array, comprising: one or more laser sensors, wherein the one or more laser sensors are configured to detect a laser signal comprising video data; one or more radio sensors, wherein the one or more radio sensors are configured to detect a radio signal comprising location data; one or more lasers, wherein the one or more lasers are configured to transmit the detected video data via a laser signal; and a motor, wherein the motor is configured to orientate the one or more lasers based on the received location data.

The laser array is able to receive video data from a video game console via a laser signal. The array can then detect the position of a virtual reality headset, or laser sensors of the headset, and orientate the one or more lasers such that the lasers transmit a laser signal comprising the video data directly to the headset. The radio signal comprising location data may be supported by Wi-Fi® or Bluetooth®, for example.

Preferably, the laser array is configured to be mounted above a user in use, such that the one or more lasers are configured to transmit the laser signal downwards.

Preferably, the laser array further comprises a mounting for attaching the laser array to a ceiling, wherein the one or more lasers are configured to transmit the laser signal downwards away from the ceiling.

In various embodiments, the laser array further comprises a camera, wherein the laser array is configured to track the motion of motion capture markers via the camera, and wherein the motor is configured to orientate the one or more lasers based on the detected motion of the motion capture markers.

In another aspect of the present invention there is provided a virtual reality headset, comprising: one or more headset laser sensors, wherein the one or more headset laser sensors are configured to detect video data transmitted by a laser signal. The one or more headset laser sensors may be oriented so as to receive a laser signal from above the user when worn.

Preferably, the virtual reality headset further comprises a motion sensor, wherein the motion sensor is configured to detect motion of the headset, and to generate headset motion data based on the detected motion of the headset; and a radio signal generator, wherein the radio signal generator is configured to transmit the headset motion data via a radio signal.

In various embodiments, the one or more laser sensors comprise one or more upper laser sensors configured to detect a laser signal transmitted from above the headset, and one or more lower laser sensors configured to detect a laser signal transmitted from below the headset. In various embodiments, the virtual reality headset further comprises one or more motion capture markers.

In another aspect of the present there is provided a method for transmitting data to a virtual reality headset, comprising: transmitting, by a video game console, console data to a laser array; receiving, by the laser array, the console data transmitted by the video game console; transmitting, by the laser array, the console data to a virtual reality headset via one or more lasers of the laser array; and receiving, by the virtual reality headset, the console data transmitted by the laser array via the one or more lasers of the laser array.

Various features of the systems and devices described herein may be implemented as methods and vice versa. Various features of the systems described herein may be implemented as devices and vice versa.

### BRIEF DESCRIPTION OF DRAWINGS

Aspects of the present invention will now be described, by way of example, by reference to the drawings, in which:

FIG. 1 is a schematic diagram of a video game system;

FIG. 2 is a schematic diagram of a video game system in an embodiment of the invention;

FIG. 3 is a schematic diagram of a video game console in another embodiment of the invention;

FIG. 4 is a schematic diagram of a laser array in another embodiment of the invention;

FIG. 5 is a schematic diagram of a virtual reality headset in another embodiment of the invention; and

FIG. 6 is a flow diagram of a method in another embodiment of the invention.

### DETAILED DESCRIPTION

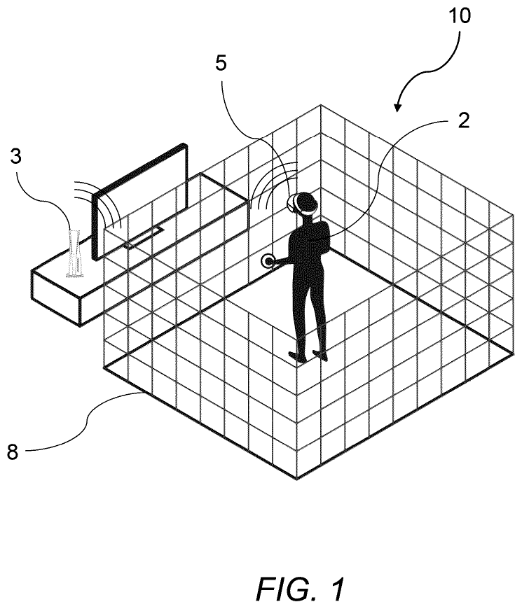

FIG. 1 is a schematic diagram of a video game system 10. The video game system 10 enables a user 2 to play video games using a virtual reality (VR) headset. The system 10 comprises a video game console 3 and a virtual reality (VR) headset 5, which the user 2 wears on their head. The VR headset 5 receives data wirelessly from the video game console 3. The VR headset 5 defines a playing area 8 which is provided around the user 2, within which the user 2 can freely move around whilst playing a video game.

In the video game system 10, the VR headset 5 receives data, which includes video data, directly from the video game console 3. This data is communicated wirelessly from the console 3 directly to the headset 5 via radio signals such as Wi-Fi®. Video data rendered by the console 3 is frequently uncompressed and therefore requires a large bandwidth to be transmitted successfully.

An issue present with the approach of the present example is that such radio signals have a low bandwidth and can be affected by crosstalk from other electronic devices within or in the vicinity of the system 10. The system 10 is therefore not effective at transmitting high-quality video data to the headset 5.

Approaches to solving this issue may include transmitting video data from a video game console to a VR headset via a physical wire. This is undesirable as a physical tether is introduced to the user, which may present a trip hazard or an unwanted restriction movement in the playing area. Improvements to the present example are therefore required, but without using a physical wire to transmit video data.

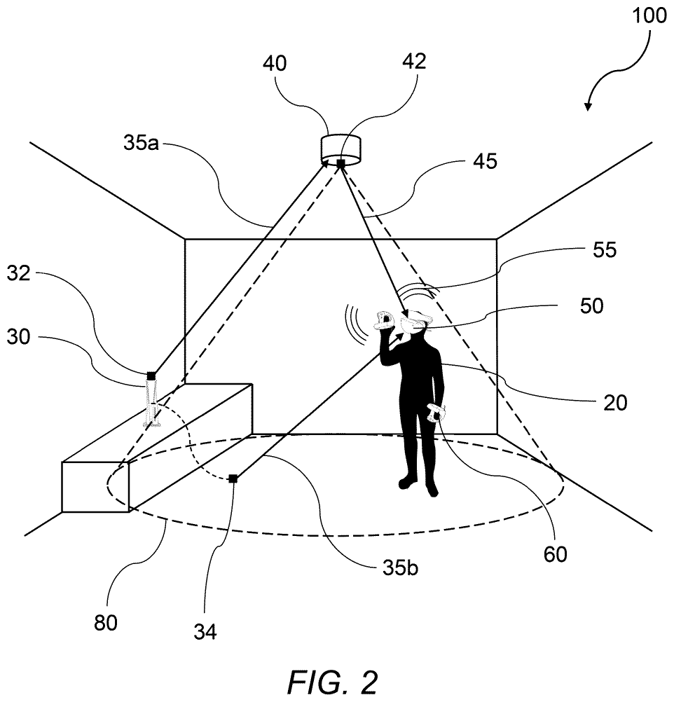

FIG. 2 is a schematic diagram of a video game system 100 in an embodiment of the invention. The video game system 100 enables a user 20 to play video games using a VR headset. The system 10 comprises a video game console 30, a laser array 40 and a VR headset 50. In this example, the laser array 40 receives console data from the video game console 30 wirelessly via a laser signal 35a. The laser array 40 also transmits the console data to the VR headset 50 wirelessly via a laser signal 45. The laser array 40 therefore acts as a data relay. Additionally, the system 100 comprises controllers 60 which the user holds in their hands, and these are connected to the VR headset 50. The laser array 40 defines a playing area 80 which is provided around the user 20, within which the user 20 can freely move around whilst playing a video game. In other examples there may be a wired data connection between the video game console 30 and the laser array 40.

The video game console 30 comprises a processor (not shown) which is configured to render video data based on video game data stored in a memory (also not shown) of the console 30. The console further comprises a console laser 32 and an auxiliary laser array 34. The console laser 32 is located on the exterior body of the console 30, whereas the auxiliary laser array 34 is spaced apart from the console 30 and is connected thereto by a wired connection. The console laser 32 is configured to directly transmit a first laser signal 35a in an upwards direction towards the laser array 40. On the other hand, the auxiliary laser array 34 is configured to directly transmit a second laser signal 35b in an upwards direction towards the VR headset 50. The first and second laser signals 35a, 35b comprise console data which includes the video data rendered by the processor. The console data may also include audio data or other types of data.

In various embodiments, the console laser 32 and the auxiliary laser array 34 may each comprise one or more individual lasers. Additionally, a plurality of auxiliary laser arrays may be provided within the system 100 and these may be connected to the console 30 via a wired or wireless connection. In alternative embodiments, the console 30 may not comprise any console lasers or auxiliary laser arrays, and may instead transmit console data including the video data to the laser array 40 by a wired connection.

The laser array 40 is configured to receive video data from the console 30 via the first laser signal 35a transmitted by the console laser 32. It may do this using a laser sensor (not shown). A laser 42 of the array 40 transmits the received video data via a laser signal 45 directly to the VR headset 50, thereby relaying the video data from the console 30 to the VR headset 50.

The array 40 further comprises a motor which is configured to orientate the laser 42 based on determined motion and/or position of the VR headset 50. More specifically, the laser 42 may be orientated based on determined motion and/or position of laser sensors of the VR headset 50. The array 40 may comprise additional sensors such as radio sensors or cameras in order to do this. The possible range of orientations of the laser 42 are confined within a cone, which corresponds to the playing area 80. Outside of the playing area 80, the VR headset 50 cannot receive data from the array 40 as the laser 42 cannot be oriented in a direction outside of this cone.

In this embodiment, the array 40 is located on the ceiling of the room in which the system 100 is disposed when in use. The laser signals 35a and 45 are less likely to be blocked in this configuration. In alternative embodiments, the array 40 may be positioned on other surfaces within the room when in use. In various embodiments, the laser array 40 may comprise one or more lasers. The motor that orientates the one or more lasers of the array may comprise a motorised gyroscope, for example, which alters the pitch and yaw of the lasers.

The VR headset 50 is configured to receive the laser signal 45 transmitted by the laser array 40 and the laser signal 35b transmitted by the auxiliary laser array 34. It can receive these signals by one or more laser sensors disposed on the exterior of the headset. Such sensors may be located on upper and lower sections of the headset, as the laser signal 45 is received from above the headset and the laser signal 35b is received from below the headset. Should one of the paths of the two laser signals 45 or 35b be blocked, the headset is still able to receive video data via the other laser signal.

The headset 50 further comprises a motion sensor (not shown), which is configured to generate motion data based on detected changes in motion of the headset. The headset 50 can then transit or broadcast this motion data to the laser array 40 via radio signals 55, or by other suitable means. In response to receiving this motion data, the motor of the laser array 40 can orientate the array lasers 42 in the direction of the headset or more specifically the laser sensors of the headset, thereby maintaining a stable data transmission. In various embodiments, the headset may additionally comprise motion capture markers. These markers can be tracked by a camera of the laser array 40. The motor of the laser array 40 can also orientate the array lasers 42 in the direction of the headset or the laser sensors of the headset based on the tracking of these markers.

The controllers 60 can additionally transmit controller data to other components of the system 100, such as the laser array 40 or the video game console 30. The controller data may comprise the position of the controller, for example.

Transmitting console data including video data via direct laser beams as described herein has the advantages of providing greater bandwidth compared to that of radio signals, whilst maintain a wireless connection between components of the system 100. The video game console 30 is able to render high detail frame buffers and transmit these to the headset 50 without using a wire or fibre. An issue with using direct laser signals in a system such as that presently described is that laser signals have a narrow beam width, which can cause data transfer to cease if the receiving device moves out of the path of transmission or if the path is blocked. Furthermore, transmitting laser light directly across free space has the consequence that there is no way to bend or manoeuvre the laser light around a corner. These issues have been accounted for in the present system, however. By implementing an orientable laser in a laser array and one or more auxiliary laser arrays, if the VR headset moves within a playing area, or if one transmission path is blocked, data transmission to the headset can still be maintained.

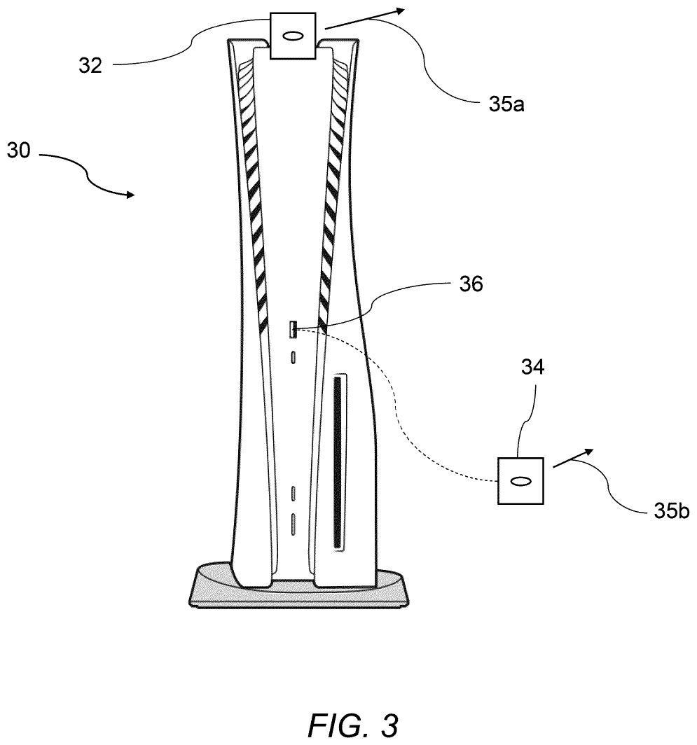

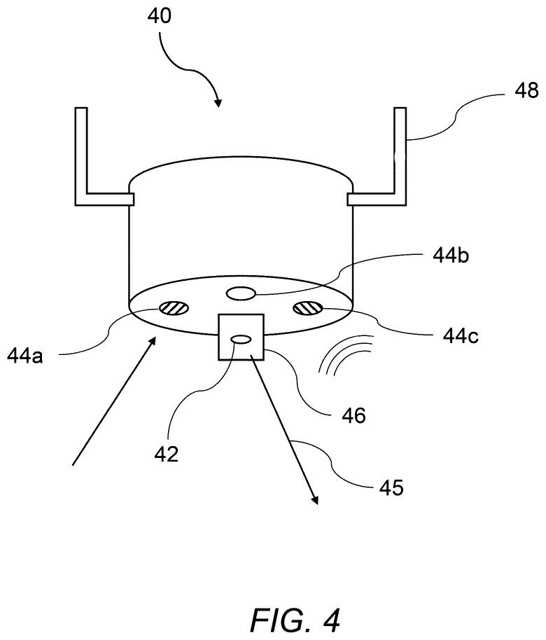

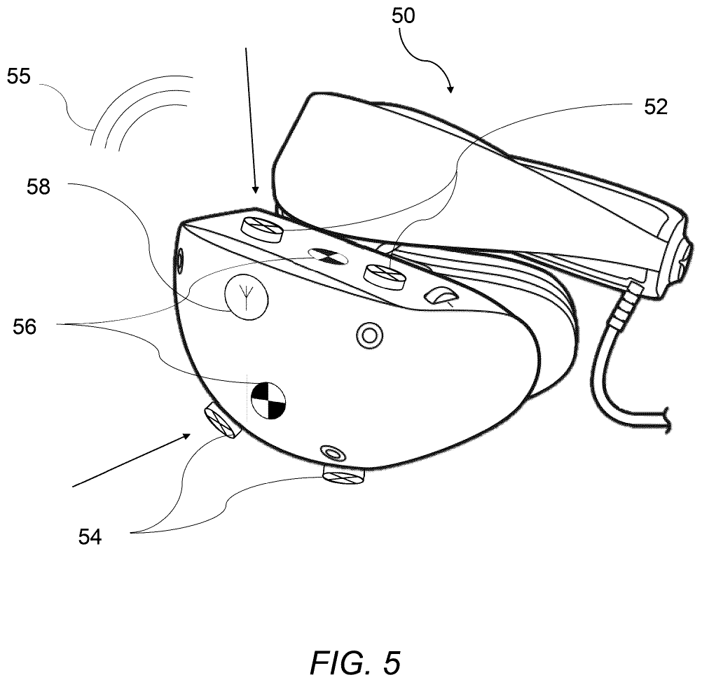

In various embodiments, the video game console 30 in the system 100 may be the video game console as described herein in relation to the embodiment according to FIG. 3, the laser array 40 may be the laser array as described herein in relation to the embodiment according to FIG. 4, and the VR headset 50 may be the VR headset as described herein in relation to the embodiment according to FIG. 5.

FIG. 3 is a schematic diagram of a video game console 30 in another embodiment of the invention. The console 30 comprises a memory (not shown) that stores video game data. The console 30 further comprises a processor (also not shown) that renders console data, which includes video data, based on the video game data stored in the memory. The console data may also include audio data or other types of data. A console laser 32 is provided in the console 30 and it is configured to transmit console data including the video data rendered by the processor via a first laser signal 35a in a first direction. An auxiliary laser 34 is connected to the console 30. It is also configured to transmit the console data including the video data rendered by the processor, but via a second laser signal 35b in a second direction. The second direction is not the same as the first direction. The auxiliary laser 34 is connected to the console 30 via a wired connection to a data communication port 36 of the console 30.

The video data rendered by the processor is communicated to the console laser 32 and the auxiliary laser 34. The processor of the console 30 may be a CPU, a GPU or a combination thereof. In particular, the rendering of the video data may be carried out by a GPU. The rendered video data is communicated directly to the console laser 32, and the console data is communicated to the auxiliary laser array 34 via the data communication port 36 and a wired connection. The console laser 32 and the auxiliary laser array 34 transmit the video data by modulating laser light. The console laser 32 and the auxiliary laser array 34 transmit the video data directly to the receiving device, in other terms a fibre optic or another medium is not used to support the laser signals. The laser signals are transmitted through free space.

The auxiliary laser array 34 may comprise a plurality of lasers configured to transmit a laser signal in the same or different directions. In various embodiments, the console 30 may comprise a plurality of console lasers and/or a plurality of auxiliary laser arrays. These additional lasers may be configured to directly transmit a laser signal in the same or different directions. In various embodiments, the console laser or lasers and/or the auxiliary laser or lasers may be integral with the video game console. Alternatively, the console laser or lasers and/or the auxiliary laser or lasers may be a separate component of the video game console and may be connected to the video game console wirelessly or by a wired connection.

The video game console 30 may comprise the same hardware as a PlayStation® 5, but in addition comprising one or more console lasers and one or more auxiliary lasers arrays that are configured to directly transmit laser signals comprising console data.

FIG. 4 is a schematic diagram of a laser array 40 in another embodiment of the invention. The laser array 40 comprises a laser 42 which is configured to transmit a laser signal 45. The array 40 further comprises three sensors 44a, 44b, and 44c. The sensor 44a is a laser sensor which can detect incident laser signals, the sensor 44b is a radio sensor which can detect incident radio signals and the sensor 44c is a camera. The array 40 also comprises a motor 46 which is configured to orientate the laser 42 based on radio signals detected by the radio sensor 44b and observations made by the camera 44c. A mounting 48 for the array 40 is provided which enables the array to be attached to a surface, for example the ceiling of a room. The laser array 40 further comprises a processor and a controller that is in communication with the laser 42, the sensors 44a, 44b, and 44c and the motor 46.

In response to receiving incident laser signals at the laser sensor 44a, the data contained within the incident laser signal is communicated to the processor of the array 40. The incident laser signal may be received from a video game console and the console data contained therein may comprise video data. The processor then instructs the laser 42 to transmit a laser signal 45 comprising the received data by modulating laser light. The laser signal 45 is transmitted towards a target, which may be a VR headset worn by a user.

The array 40 is able to determine the position of the target and orientate the laser 42 based on this using the motor 46. More specifically, the position of laser sensors of the target may be determined, and the laser may be orientated based on this. If the radio sensor 44b receives incident radio signals from the target which comprise motion data indicating motion of the target, the radio sensor 44b can communicate this motion data to the processor. The processor can then instruct the controller to actuate the motor and orientate the laser 42 based on the received motion data.

Furthermore, if the camera 44c observes that the position of the target has changed, the camera can communicate this to the processor. The camera 44c is configured to track motion capture markers disposed on the target in particular. The processor can then then instruct the controller to actuate the motor and orientate the laser 42 based on the observations made by the camera. The laser array 40 is therefore able to detect motion of a target and maintain a direct line of sight between the laser 42 and the target such that communication is not lost. More specifically, the position of laser sensors of the target may be determined, and the laser may be orientated based on this.

As depicted in FIG. 4, the array 40 comprises a laser 42 that directly transmits a laser signal 45 in a downwards direction. No fibre optic or other medium is used to couple the laser 45 transmitted by the laser 42. In various embodiments, the array 40 may comprise a plurality of individual laser emitters. These emitters may be orientated in the same direction or in different directions.

The mounting 48 may be a bracket or another type of fixing. In alternative embodiments, the mounting 48 may be configured to enable the array to be removably affixed to the ceiling of a room.

FIG. 5 is a schematic diagram of a VR headset 50 in another embodiment of the invention. The VR headset 50 comprises upper laser sensors 52 and lower laser sensors 54. These laser sensors are configured to detect laser signals comprising console data including video data transmitted above and below the VR headset, respectively. The VR headset 50 further comprises motion capture markers 56 which enable detection of motion and position of the headset 50. The headset 50 further comprises a motion sensor (not shown) which detects motion of the headset 50 and generates motion data from the detected motion. A radio signal generator 58 of the headset 50 transmits the motion data via a radio signal 55 using an antenna. The headset 50 also comprises a processor (not shown) for rendering the received video data and a display (also not shown) for displaying the rendered video data to a wearer.

The upper laser sensors 52 are configured to detect laser signals transmitted downwards towards the headset 50 from a laser positioned above. These laser signals may be transmitted by a laser of a laser array disposed on the ceiling of a room in which the wearer is located. The lower laser sensors 54 are configured to detect laser signals transmitted upwards towards the headset 50 from a laser positioned below. These laser signals may be transmitted by a laser of an auxiliary laser array disposed adjacent to a video game console, which is disposed in a room in which the wearer is located.

Upon receiving the laser signals, which comprise video data, the video data contained therein is communicated to the processor of the headset, which renders the received video data and communicates this to the display.

As depicted in FIG. 5, the headset 50 comprises two motion capture markers 56. One of these markers is disposed on an upper section of the headset and the other marker is disposed on a lower section of the headset. A camera can therefore detect the markers 56 in most use cases, regardless of the orientation of the camera or the headset. For example, if the camera is positioned above the wearer, the camera is able to observe the upper marker. If the user were to look up whilst wearing the headset 50 during gameplay, the same camera would be able to observe the lower marker. The upper marker is disposed proximally to the upper laser sensors 52 and the lower marker is disposed proximally to the lower laser sensors.

The motion sensor of the headset 50 may sample motion of the headset periodically to produce motion data. Alternatively, the motion sensor may only produce motion data when it detects a change in motion of the headset 50. In various embodiments, the motion sensor may be an inertial measurement unit (IMU) such as an accelerometer or a gyroscope, or a combination thereof. The motion sensor communicates the detected motion of the headset to the radio signal generator 58, which generates a radio signal comprising the motion data. The generator 58 transmits this via an antenna.

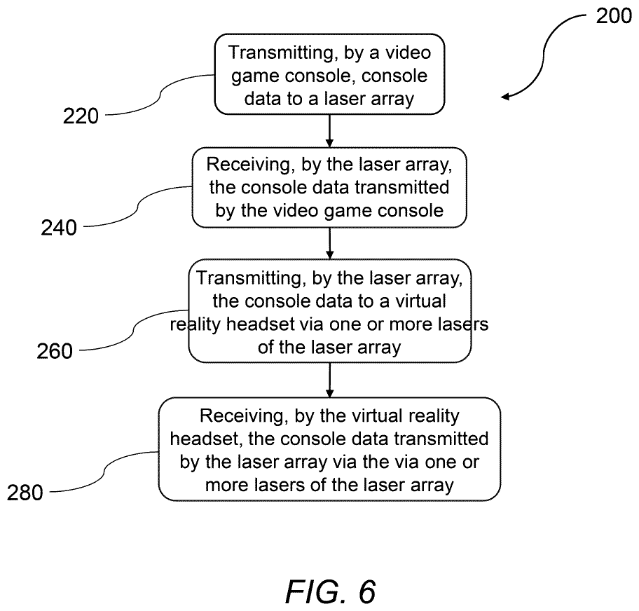

FIG. 6 is a flow diagram of a method 200 in another embodiment of the invention. The method 200 comprises steps 220, 240, 260 and 280. Step 220 comprises transmitting, by a video game console, console data to a laser array. Step 240 comprises receiving, by the laser array, the console data transmitted by the video game console. Step 260 comprises transmitting, by the laser array, the console data to a virtual reality headset via one or more lasers of the laser array and step 280 receiving, by the virtual reality headset, the console data transmitted by the laser array via the one or more lasers of the laser array.

In particular, step 220 comprises transmitting video data to the laser array via a laser signal transmitted by a console laser of the video game console. In alternative embodiments, the console data may be transmitted by another mechanism, such as a wired connection. Additionally, console data may be transmitted to the laser array using an auxiliary laser array that is connected to the console.

More specifically, step 240 comprises receiving, by one or more laser sensors of the laser array, the video data transmitted by the console laser of the video game console. In alternative embodiments, the video data may be received at the laser array by another mechanism, such as a wired connection. Additionally, console data may be received at the laser array from an auxiliary laser array that is connected to the console.

Step 260 specifically comprises transmitting, by the laser array, the video data to a virtual reality headset via one or more lasers of the laser array. The video data may be transmitted to the virtual reality headset in a particular direction based on a determined position of the virtual reality headset. The laser array may receive motion data from the virtual reality headset which is indicative of the position of the headset or laser sensors of the headset. In response to receiving this motion data, the video data may be transmitted to the virtual reality headset directly towards the headset. This motion data may comprise radio signals or images or the headset.

Step 280 comprises, in particular, receiving, by one or more laser sensors of the virtual reality headset, the video data transmitted by the laser array via the one or more lasers of the laser array.

1. A system for transmitting data to a virtual reality headset, comprising:
a laser array comprising one or more lasers, wherein the laser array is configured to receive console data transmitted from a video game console; and
a virtual reality headset comprising one or more headset sensors, wherein the laser array is configured to transmit the console data to the one or more headset sensors via the one or more lasers of the laser array.

2. A system according to claim 1, wherein the one or more lasers are configured to emit a direct laser beam towards the one or more headset sensors.

3. The system according to claim 1, wherein the laser array is configured to be positioned above the virtual reality headset in use.

4. The system according to claim 1, further comprising:
one or more auxiliary laser arrays each comprising one or more auxiliary lasers, wherein the one or more auxiliary laser arrays are configured to receive the console data transmitted from the video game console, and wherein the one or more auxiliary laser arrays are configured to transmit the console data to the one or more headset sensors via the one or more auxiliary lasers of the one or more auxiliary laser arrays.

5. The system according to claim 1, wherein the laser array comprises one or more array sensors configured to detect optical signals transmitted by the video game console and/or the virtual reality headset.

6. The system according to claim 5, further comprising a video game console, wherein the video game console comprises a console laser, and wherein the video game console is configured to transmit the console data to the one or more array sensors via the console laser.

7. The system according to claim 1, wherein the laser array is configured to track the motion of the virtual reality headset to determine a position of the virtual reality headset, and wherein the one or more lasers of laser array are configured to be orientated in a direction facing the virtual reality headset based on the determined position of the virtual reality headset.

8. The system according to claim 7, wherein the laser array comprises a motor configured to change the orientation the one or more lasers of the laser array based on the determined position of the virtual reality headset.

9. The system according to claim 7, wherein the laser array tracks the motion of the virtual reality headset at least in part by tracking motion capture markers located on the virtual reality headset via a camera.

10. The system according to claim 1, wherein the virtual reality headset comprises a motion sensor configured to detect motion of the virtual reality headset, and wherein the motion sensor is configured to generate headset motion data based on the detected motion of the virtual reality headset.

11. The system according to claim 10, wherein the virtual reality headset is configured to transmit the headset motion data to the one or more array sensors, and wherein the laser array tracks the motion of the virtual reality headset based at least in part on the headset motion data.

12. The system according to claim 1, wherein the one or more headset sensors comprise one or more top-mounted sensors and/or one or more bottom-mounted sensors, wherein the top-mounted sensors are mounted on an upper section of the virtual reality headset and the bottom-mounted sensors are mounted on a lower section of the virtual reality headset.

13. The system according to claim 1, wherein the console data comprises video data.

14. A laser array, comprising:
one or more laser sensors, wherein the one or more laser sensors are configured to detect a laser signal comprising video data;
one or more radio sensors, wherein the one or more radio sensors are configured to detect a radio signal comprising location data;
one or more lasers, wherein the one or more lasers are configured to transmit the detected video data via a laser signal; and
a motor, wherein the motor is configured to orientate the one or more lasers based on the received location data.

15. The laser array according to claim 14, wherein the laser array is configured to be mounted above a user in use, such that the one or more lasers are configured to transmit the laser signal downwards.

16. The laser array according to claim 15, further comprising:
a mounting for attaching the laser array to a ceiling, wherein the one or more lasers are configured to transmit the laser signal downwards away from the ceiling.

17. The laser array according to claim 14, further comprising:
a camera, wherein the laser array is configured to track the motion of motion capture markers via the camera, and wherein the motor is configured to orientate the one or more lasers based on the detected motion of the motion capture markers.

18. A virtual reality headset, comprising:
one or more headset laser sensors, wherein the one or more headset laser sensors are configured to detect video data transmitted by a laser signal.

19. The virtual reality headset according to claim 18, further comprising:
a motion sensor, wherein the motion sensor is configured to detect motion of the headset, and to generate headset motion data based on the detected motion of the headset; and
a radio signal generator, wherein the radio signal generator is configured to transmit the headset motion data via a radio signal.

20. The virtual reality headset according to claim 18, wherein the one or more laser sensors comprise one or more upper laser sensors configured to detect a laser signal transmitted from above the headset, and one or more lower laser sensors configured to detect a laser signal transmitted from below the headset.
